(19) United States
(12) Patent Application Publication
(10) Pub. No.: US 2015/0205183 A1
(43) Pub. Date: Jul. 23, 2015

(54) Mobile telephone application for a lighted mirror effect

(71) Applicant: Pamela A. Gsellman, Akron, OH (US)

(72) Inventor: Pamela A. Gsellman, Akron, OH (US)

(21) Appl. No.: 14/603,315

(22) Filed: Jan. 22, 2015

Related U.S. Application Data
(60) Provisional application No. 61/929,205, filed on Jan. 20, 2014.

(51) Int. Cl. G03B 15/02; G09G 3/22; H04N 5/235; A45D 42/04; G09G 3/34; H04N 5/232

(52) U.S. Cl. CPC G03B 15/02; G09G 3/3406; H04N 5/23293; H04N 5/2351; A45D 42/04; G09G 3/22; G09G 2320/0626; G09G 2310/024; G09G 2360/144; G09G 2360/145; G09G 2354/00; A45C 2011/002

(57) ABSTRACT

A mobile application with a lighted mirror effect features an image area created by the smartphone's user-directed camera. The application may provide a perimeter of illumination discs around the image area. Alternately, illumination may be achieved with the camera flash. A high-resolution user-directed camera and a flash associated with the user-directed camera are preferred hardware. Alternately, a smartphone visual display may be provided having a selectively higher reflectivity than a standard visual display. When combined with a peripheral light or backlight, a lighted mirror effect may be achieved. The application may also be used to take a self-portrait photograph.

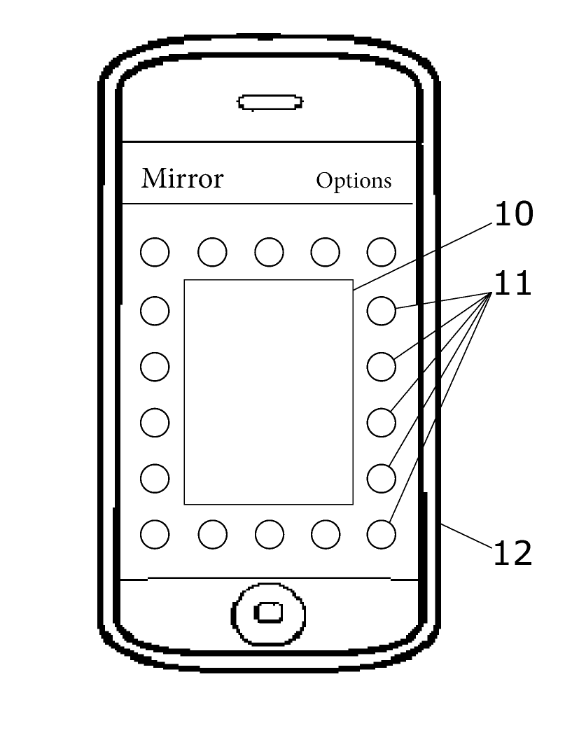

### CROSS-REFERENCE TO RELATED APPLICATIONS

This Application claims the benefit of U.S. Provisional Application No. 61/930,019, filed Jan. 22, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to mobile applications, and in particular to a mobile application with a lighted mirror effect. The general trend for today's personal accessories is to travel light, with most accessories being made smaller and serving multiple purposes. The smartphone, for example, resulted from the combination of the cellular telephone and the personal digital assistant (PDA). Carrying a compact or mirror, to be used when checking one's appearance or applying makeup, has been a standard feature in most women's purses. But many women, seeking to travel light, would prefer to be able to do away with it. A mobile application with a lighted mirror effect would satisfy this demand.

### SUMMARY OF THE INVENTION

Accordingly, the invention is directed to a mobile application with a lighted mirror effect. The application provides an image area created by the smartphone's user-directed camera. The application may provide a perimeter of illumination discs around the image area. Alternately, illumination may be achieved with the camera flash. A high-resolution user-directed camera and a flash associated with the user-directed camera are preferred hardware. Alternately, a smartphone visual display may be provided having a selectively higher reflectivity than a standard visual display. When combined with a peripheral light or backlight, a lighted mirror effect may be achieved. The application may also be used to take a self-portrait photograph.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrate one embodiment of the invention and, together with the description, serves to explain the principles of the invention.

The FIGURE is a front view of the first exemplary embodiment, displaying the image area 10, the illumination discs 11, and the smartphone 12.

### DETAILED DESCRIPTION OF THE INVENTION

Referring now to the invention in more detail, the invention is directed to a mobile application with a lighted mirror effect. The application provides an image area 10 created by the smartphone's user-directed camera. The application may provide a perimeter of illumination discs 11 around the image area 10. A high-resolution user-directed camera and a flash associated with the user-directed camera are preferred hardware. The application may also be used to take a self-portrait photograph, optionally including the illumination discs 11 as a visual enhancement.

One exemplary embodiment is provided. The first exemplary embodiment is provided employing the user-directed camera of a smartphone 12 or a tablet (generically, a mobile computing device having a user-facing camera). The image obtained by the user-directed camera is reversed by the mobile application to create a mirror effect, and displayed in the image area 10 on the visual display of the smartphone 12 or tablet. The mobile application further provides a plurality of illumination discs 11, surrounding the perimeter of the image area 10. Illumination discs 11 are created by providing a bright white circular area on the visual display. The plurality of illumination discs 11 are sufficient to illuminate the user's face for the application of makeup, checking the user's appearance, combing hair or performing other minor grooming tasks, by viewing the image area 10.

The activation and brightness of the illumination discs 11, and magnification of the image in the image area, are controlled using the options menu in the mobile application. The user may also use the mobile application to take a self-portrait photograph. An alternate embodiment, wherein a smartphone visual display may be provided having a selectively higher reflectivity than a standard visual display, combined with a peripheral light or backlight to achieve a lighted mirror effect, is also contemplated. Other alternate embodiments, wherein illumination may be achieved with the camera flash, are also contemplated. Generically, the illumination discs 11, other illumination display shapes (e.g. squares, solid white), activating the camera flash, or engaging with ambient lighting may be understood as activating an illuminating means for illuminating the image taken from the user facing camera.

To use the first exemplary embodiment, the user activates the mobile application to display the user's image in the image area 10. The user may then activate the illumination discs 11 and adjust their brightness as desired, using the mobile application. The user may then check the user's appearance, apply makeup, or perform other minor grooming tasks while observing the image area 10.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A method for a lighted mirror software application comprising a method of operating a mobile computing device having a user facing camera, the method comprising:
(a) displaying an image area;
(b) displaying the image taken from said user facing camera in said image area; and
(c) activating an illuminating means for illuminating the image taken from said user facing camera.

2. The method of claim 1 wherein said illuminating means for illuminating the image taken from said user facing camera comprises displaying a plurality of illumination discs; said illumination discs being displayed so as to surround said image area.

3. The method of claim 1 wherein said illuminating means for illuminating the image taken from said user facing camera comprises activating the camera flash.

4. The method of claim 1 further comprising magnifying the image taken from said user facing camera.

5. The method of claim 2 further comprising magnifying the image taken from said user facing camera.

6. The method of claim 3 further comprising magnifying the image taken from said user facing camera.

7. The method of claim 1 further comprising selectively storing the image taken from said user facing camera as a portrait photograph.

8. The method of claim 2 further comprising selectively storing the image taken from said user facing camera as a portrait photograph.

9. The method of claim 3 further comprising selectively storing the image taken from said user facing camera as a portrait photograph.

10. The method of claim 4 further comprising selectively storing the image taken from said user facing camera as a portrait photograph.

11. The method of claim 5 further comprising selectively storing the image taken from said user facing camera as a portrait photograph.

12. The method of claim 6 further comprising selectively storing the image taken from said user facing camera as a portrait photograph.

13. A computer system, the system comprising a mobile computing device having a forward facing camera; said mobile computing device being configured for:
(a) displaying an image area;
(b) displaying the image taken from said user facing camera in said image area;
(c) displaying a plurality of illumination discs; and
(d) said illumination discs being displayed so as to surround said image area.

14. The computer system of claim 13 wherein said mobile computing device is further configured for magnifying the image taken from said user facing camera.

15. The computer system of claim 13 wherein said mobile computing device is further configured for selectively storing the image taken from said user facing camera as a portrait photograph.

16. The computer system of claim 14 wherein said mobile computing device is further configured for selectively storing the image taken from said user facing camera as a portrait photograph.

17. A computer program product, said computer program product being embodied in a tangible non-transitory computer readable storage medium and comprising computer instructions for:
(a) displaying an image area;
(b) displaying the image taken from a user facing camera in said image area;
(c) displaying a plurality of illumination discs; and
(d) said illumination discs being displayed so as to surround said image area.

18. The computer program product of claim 17 further comprising computer instructions for magnifying the image taken from said user facing camera.

19. The computer system of claim 17 further comprising computer instructions for selectively storing the image taken from said user facing camera as a portrait photograph.

20. The computer system of claim 19 further comprising computer instructions for selectively storing the image taken from said user facing camera as a portrait photograph.
